(19) United States
(12) Patent Application Publication
(10) Pub. No.: US 2013/0155228 A1
(43) Pub. Date: Jun. 20, 2013

(54) MOVING OBJECT DETECTION METHOD AND APPARATUS BASED ON COMPRESSED DOMAIN

(71) Applicants: En-Jung Farn, Hsinchu City (TW); Shen-Zheng Wang, Taoyuan County (TW); Yue-Min Jiang, New Taipei City (TW); Cheng-Chang Lien, Hsinchu County (TW)

(72) Inventors: En-Jung Farn, Hsinchu City (TW); Shen-Zheng Wang, Taoyuan County (TW); Yue-Min Jiang, New Taipei City (TW); Cheng-Chang Lien, Hsinchu County (TW)

(73) Assignee: Industrial Technology Research Institute, Hsinchu (TW)

(21) Appl. No.: 13/368,342

(22) Filed: Feb. 8, 2012

(30) Foreign Application Priority Data
Dec. 19, 2011 (TW) 100147187

(51) Int. Cl. G06K 9/46; H04N 7/18

(52) U.S. Cl. 348/143; 348/E07.085

(57) ABSTRACT

A moving object detection method and a moving object detection apparatus based on a compressed domain are disclosed. In the method, compressed video data and pixel video data are received. Moving object information in the first compressed video data is detected and integrated into the pixel video data. The pixel video data containing the moving object information is output.

### CROSS-REFERENCE TO RELATED APPLICATION

This application claims the priority benefit of Taiwan application serial no. 100147187, filed Dec. 19, 2011. The entirety of the above-mentioned patent application is hereby incorporated by reference herein and made a part of this specification.

### BACKGROUND

1. Technical Field

The disclosure relates to a moving object detection method and a moving object detection apparatus.

2. Related Art

Along with the fast development of video system technology in recent years, real-time video surveillance has become a major subject in the security field. Real-time video surveillance comes with many different issues, such as human/car classification, people counting, and object tracking. However, all these issues may be based on a most ultimate issue, that is, moving object detection.

In existing object detection methods based on the pixel domain, the most commonly adopted technique is to establish a background model, such as a Gaussian mixture model (GMM) or a hidden Markov model (HMM), for capturing moving object(s). In these methods, a model has to be established and constantly updated regarding each pixel in a frame, and accordingly, long operation time is required. Even though real-time operation can be accomplished by using existing hardware equipments and a common video camera, along with the great advancement of video camera technology, real-time video surveillance systems are expected to provide video frames with higher quality. The object detection methods based on the pixel domain may eventually fail to provide real-time detection result along with the increase in pixel number of video frames.

Additionally, an video camera compresses a video frame into a format (for example, H.264 format) in order to reduce the transmission time. Since most video cameras in current market are megapixel cameras, the original baseline profile has been gradually replaced. Because only intra frames (I-frames) and prediction frames (P-frames) are compressed in the baseline profile, the performance of the baseline profile is not very satisfactory. However, if bidirectional frames (B-frames) are further used for compression, the compression quality and performance can be greatly improved. Thus, video cameras have started to adopt the main or high profile, in which I-frames, P-frames, and B-frames are all compressed, in pursuit of higher frame quality. Besides, instead of non-stationary video cameras, dynamic video cameras are adopted in some surveillance systems for tracking moving objects.

Generally, after a decoder decompresses a received video data into pixel video frames according to a compression specification, an object detection module based on the pixel domain can perform moving object detection on these pixel video frames. However, this operation may require a background model to be established for each pixel in the pixel video frames, which is very time-consuming in current megapixel video cameras.

### SUMMARY

A moving object detection method and a moving object detection apparatus based on a compressed domain are introduced herein, in which moving object information detected in the compressed domain is integrated into a pixel video frame and provided for example to a back-end device to perform further operation(s).

According to an embodiment of the disclosure, a moving object detection method based on a compressed domain is provided. In the moving object detection method, first compressed video data and pixel video data are received. Moving object information in the first compressed video data is detected and integrated into the pixel video data. The pixel video data containing the moving object information is output.

According to an embodiment of the disclosure, a moving object detection apparatus based on a compressed domain is provided. The moving object detection apparatus includes a moving object detection module and an information integration module. The moving object detection module receives first compressed video data and detects moving object information in the first compressed video data. The information integration module integrates the moving object information and received pixel video data, and outputs the pixel video data containing the moving object information.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic block diagram of a moving object detection apparatus based on a compressed domain according to an embodiment of the disclosure.

FIG. 2 is a block diagram of a moving object detection apparatus based on a compressed domain according to an embodiment of the disclosure.

FIG. 3 is a flowchart of a moving object detection method based on a compressed domain according to an embodiment of the disclosure.

FIG. 4 is a block diagram of a moving object detection module according to an embodiment of the disclosure.

FIG. 5 is a flowchart of a moving object detection method according to an embodiment of the disclosure.

FIG. 6 illustrates an example of median filtering of motion vectors according to an embodiment of the disclosure.

FIG. 7 is a flowchart illustrating a method for identifying moving object blocks by using a broad domain motion vector according to an embodiment of the disclosure.

### DETAILED DESCRIPTION OF DISCLOSED EMBODIMENTS

The disclosure provides a moving object detection method and a moving object detection apparatus adapted to a dynamic or stationary video camera, in which the video camera is allowed to compress video data based on a compressed domain according to a baseline profile, a main profile, or a high profile in a compression format. The moving object detection method in the disclosure can be applied to video data containing one or more video frames based on the H.264 compressed domain and compliant with the MPEG-1 or MPEG-2 compression specification. However, the scope of the disclosure is not limited thereto.

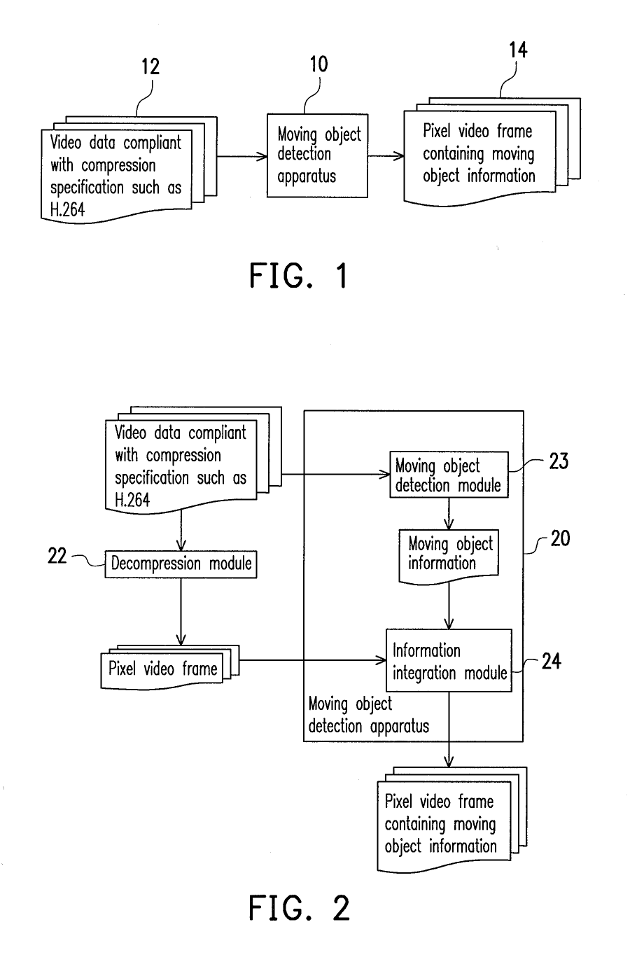

FIG. 1 is a schematic block diagram of a moving object detection apparatus based on a compressed domain according to an embodiment of the disclosure. Referring to FIG. 1, the moving object detection apparatus 10 in the present embodiment receives a video data 12 compliant with compression specification such as H.264, captures motion vector information of video frames in the H.264 compressed domain to carry out moving object detection, and decompresses the video data 12 into a pixel video frame according to the H.264 specification. Thereafter, the moving object detection apparatus 10 marks a moving object in the pixel video frame according to user requirement and the moving object detection result or hides detailed moving object information into the pixel video frame by using an information hiding technique and outputs a pixel video frame 14 containing the moving object information. The moving object detection apparatus 10 in the present embodiment can replace a H.264 decoder and an object detection module and therefore can greatly improve the device efficiency and leave more operation time to subsequent intelligent object analysis module.

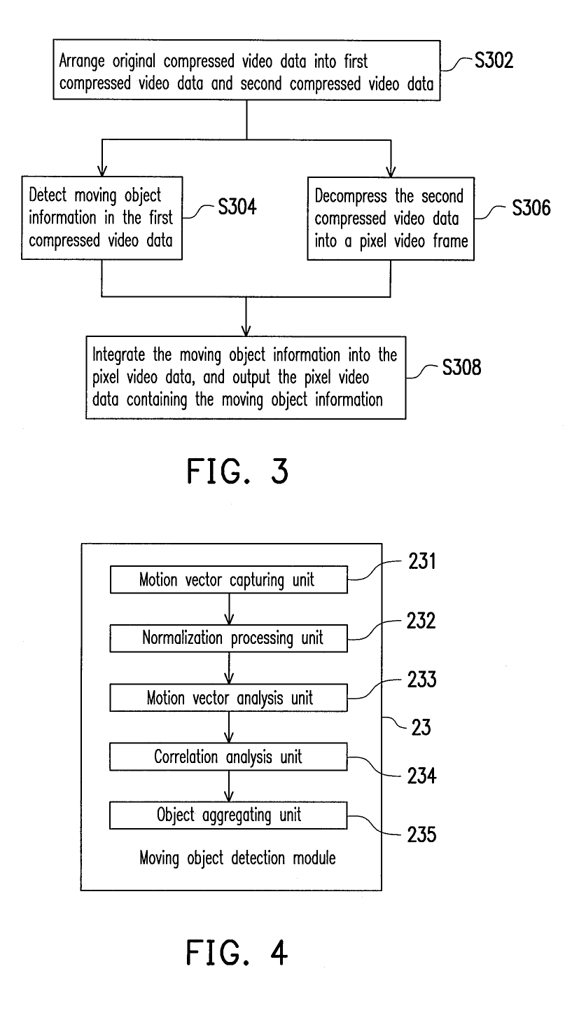

FIG. 2 is a block diagram of a moving object detection apparatus based on a compressed domain according to an embodiment of the disclosure. FIG. 3 is a flowchart of a moving object detection method based on a compressed domain according to an embodiment of the disclosure. Referring to both FIG. 2 and FIG. 3, the moving object detection apparatus 20 in the present embodiment includes a moving object detection module 23 and an information integration module 24. In addition, the moving object detection apparatus 20 may selectively include a decompression module 22. Below, a moving object detection method in the present embodiment will be described in detail with reference to various components illustrated in FIG. 2.

Original compressed video data compliant with the H.264 compression specification is arranged into a first compressed video data and a second compressed video data, and the first compressed video data and the second compressed video data are respectively provided to the moving object detection module 23 and the decompression module 22 (step S302). Herein the second compressed video data containing profiles, intra frames (I-frames), prediction frames (P-frames), and bidirectional frames (B-frames) in the original compressed video data is sent to the decompression module 22, and the first compressed video data containing P-frames, and B-frames is sent to the moving object detection module 23.

After the decompression module 22 receives the second compressed video data, it decompresses the received I-frames, P-frames, or B-frames into pixel video frames according to the compression format of the compressed video data and the specification of the received profile (for example, a baseline profile, a main profile, or a high profile) and sends the pixel video frames to the information integration module 24 (step S306).

After the moving object detection module 23 receives the first compressed video data, it captures information of the P-frames and B-frames in the first compressed video data in the compressed domain, carries out a moving object detection process to obtain moving object information, and sends the moving object information to the information integration module 24 (step S304).

The information integration module 24 receives the pixel video frames from the decompression module 22 and the moving object information from the moving object detection module 23, integrates the moving object information into the pixel video data, and outputs pixel video data containing the moving object information (step S308). Herein the information integration module 24 may directly mark the moving object in the pixel video frames according to the moving object information or integrate the moving object information into the pixel video data by using an information hiding algorithm, such as a least significant bit replacement algorithm or a wet paper code (WPC) algorithm.

Through the information integration described above, after receiving the pixel video frames from the moving object detection apparatus 20, a user can see the marked moving object clearly or obtain the detailed moving object information from the pixel video frames according to the information hiding algorithm used by the information integration module 24, so that the step for detecting the moving object can be saved and subsequent intelligent object analysis can be directly performed. Thereby, the moving object detection apparatus 20 offers a moving object pre-detection mechanism and therefore can replace the decoder in any system, infrastructure, or application program which requires moving object detection.

Taking the H.264 format as an example, all H.264 frames are composed of 4×4, 4×8, 8×4, 8×8, 8×16, 16×8, and 16×16 blocks, and H.264 frames can be categorized into following three types.

I-frames: all blocks use intra-prediction, and none of the blocks has motion vector. Thus, the moving object detection module 23 does not process I-frames.

P-frames: all blocks use intra-prediction or inter-prediction, each of the blocks using inter-prediction has only one motion vector, and the motion vector can only refer to a previous frame.

B-frames: all blocks use intra-prediction or inter-prediction, each of those blocks using inter-prediction has two motion vectors, and these two motion vectors can refer to a previous frame or a post frame.

In this disclosure, information of all blocks using inter-prediction in the P-frames and B-frames of the compressed domain may be captured to carry out moving object detection. Aforementioned information contains the position, size, and motion vector of each block in the frames. As to a B-frame, each block has two motion vectors and two corresponding weights. Aforementioned information affects the result of the moving object detection process. Thereby, the disclosure provides a complete technical solution of moving object detection to obtain the optimal moving object detection result.

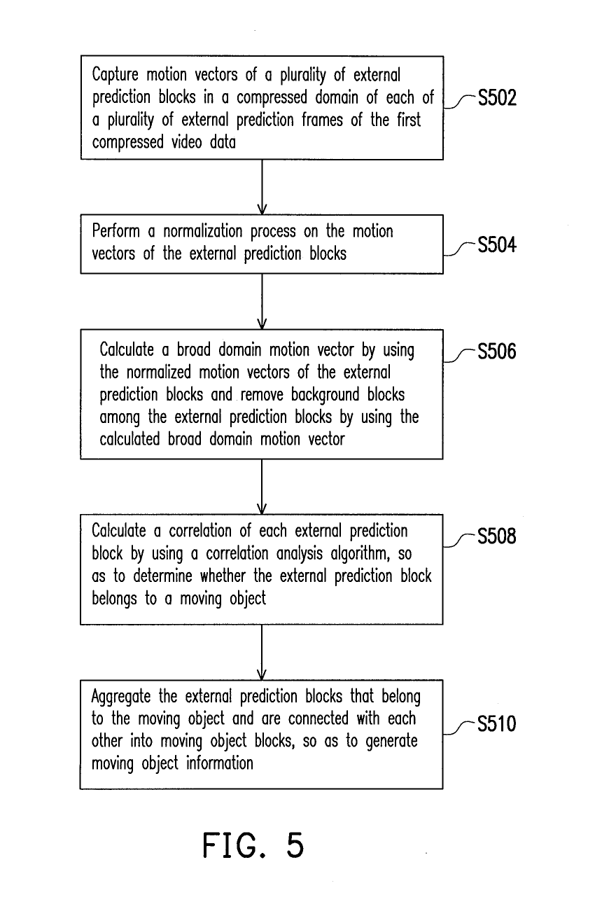

FIG. 4 is a block diagram of a moving object detection module according to an embodiment of the disclosure. FIG. 5 is a flowchart of a moving object detection method according to an embodiment of the disclosure. Referring to both FIG. 4 and FIG. 5, in the present embodiment, how the moving object detection module 23 in FIG. 2 performs moving object detection is explained in detail. The moving object detection module 23 includes a motion vector capturing unit 231, a normalization processing unit 232, a motion vector analysis unit 233, a correlation analysis unit 234, and an object aggregating unit 235. Below, the moving object detection method in the present embodiment is described in detail with reference to various components illustrated in FIG. 4.

First, the motion vector capturing unit 231 receives a compressed video data and captures motion vectors of a plurality of external prediction blocks in a compressed domain of each of a plurality of external prediction frames (step S502). Herein the motion vector capturing unit 231 may capture the motion vectors in previous P-frames and the motion vectors in previous or post B-frames.

Then, the normalization processing unit 232 performs a normalization process on the motion vectors of the external prediction blocks (step S504). Because the reference frames of each external prediction block may be in two different directions, to unify the moving direction of the blocks, the normalization processing unit 232 first performs a direction normalization on the motion vectors of all P-frames or B-frames. To be specific, the normalization processing unit 232 performs a normalization process in a reference direction of the reference frame of each external prediction block on the motion vector of the external prediction block. For example, the normalization processing unit 232 reverses the directions of the motion vectors MV(x,y) of all previous frames to obtain normalized motion vectors Inv(MV(x,y)), as expressed below:

Inv(MV(x,y))={MV(−x,−y)} (1)

On the other hand, because the reference distance (Δt) between the frame that the external prediction block refers to and the frame where the external prediction block is located is not fixed, the normalization processing unit 232 further performs a time normalization on the motion vectors of all P-frames or B-frames. To be specific, the normalization processing unit 232 performs a normalization process for a reference distance between the frame where each external prediction block is located and the frame that the external prediction block refers to on the motion vector MV(x,y) of the external prediction block to obtain a normalized motion vector Time_Norm(MV(x,y)), as expressed below:

$$Time\_Norm ( M V ( x , y ) ) = \{ M V ( \frac{x}{Δ t} , \frac{y}{Δ t} ) \} \qquad ( 2 )$$

Moreover, each block of the B-frames has two motion vectors (MV1, MV2), and these two motion vectors have corresponding weights (W1, W2, and W1+W2=1). Herein each block of the B-frames is constructed by adding up the products of two reference blocks corresponding to the two motion vectors and the corresponding weights. Accordingly, the normalization processing unit 232 respectively multiplies the two motion vectors MV₁(x,y) and MV₂(x,y) of each block by corresponding weights W₁ and W₂ and adds up the products to obtain a combined motion vector Combine(MV(x,y)) as the motion vector of the block, as expressed below:

Combine(MV(x,y))={W₁×MV₁(x,y)+W₂×MV₂(x,y)} (3)

Even though in most cases motion vectors can represent the movement of an object in the frames, the motion vectors may be determined by taking compression efficiency into consideration. Thus, in some cases, the motion vectors cannot reflect the movement of an object. To resolve this problem, in an embodiment of the disclosure, a median filtering process is performed on the motion vector of each external prediction block. Because blocks in H.264 compressed frames have different sizes, the normalization processing unit 232 calculates a mean vector of motion vectors of a plurality of adjoining blocks around each external prediction block in the same frame, calculates a difference (for example, an Euclidian distance) between the motion vector of the external prediction block and the mean vector, and compares the difference with a threshold. If the difference is greater than the threshold, the normalization processing unit 232 replaces the motion vector of the external prediction block with the mean vector. Below, an embodiment is described in detail.

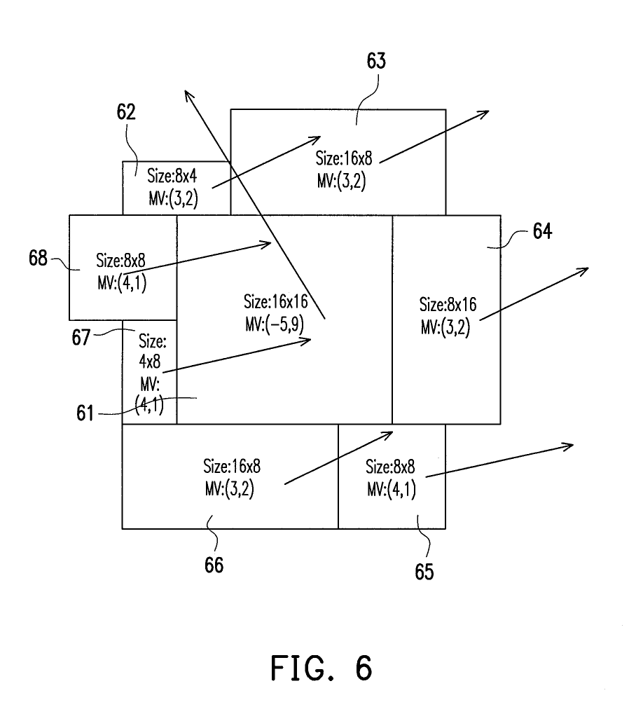

FIG. 6 illustrates an example of median filtering of motion vectors according to an embodiment of the disclosure. Referring to FIG. 6, the size of a current block is 16×16, and the motion vector thereof is (−5, 9). Starting from the top left and going clockwise, the adjoining blocks around the current block are sequentially an 8×4 block 62 having a motion vector (3,2), a 16×8 block 63 having a motion vector (3,2), an 8×16 block 64 having a motion vector (3,2), an 8×8 block 65 having a motion vector (4,1), a 16×8 block 66 having a motion vector (3,2), a 4×8 block 67 having a motion vector (4,1), and an 8×8 block 68 having a motion vector (4,1). In the present embodiment, only those blocks directly adjoin the current block 61 are taken into consideration, and 4×4 is taken as the unit of these blocks. Starting from the top left and going clockwise, the motion vectors are sequentially (3,2), (3,2), (3,2), (3,2), (3,2), (3,2), (3,2), (3,2), (4,1), (3,2), (3,2), (3,2), (4,1), (4,1), (4,1), and (4,1), and a mean vector (3,2) of these motion vectors is obtained through rounding. The Euclidian distance between the mean vector and the original motion vector (−5, 9) is very large. Thus, in the present embodiment, the motion vector of the current block 61 is changed to (3, 2).

Referring to FIG. 5 again, next, the motion vector analysis unit 233 calculates a broad domain motion vector based on the normalized motion vectors of the external prediction blocks and removes background blocks among the external prediction blocks by using the calculated broad domain motion vector (step S506). Herein the motion vector analysis unit 233 uses the broad domain motion vector to identify blocks belonging to a moving object in each frame.

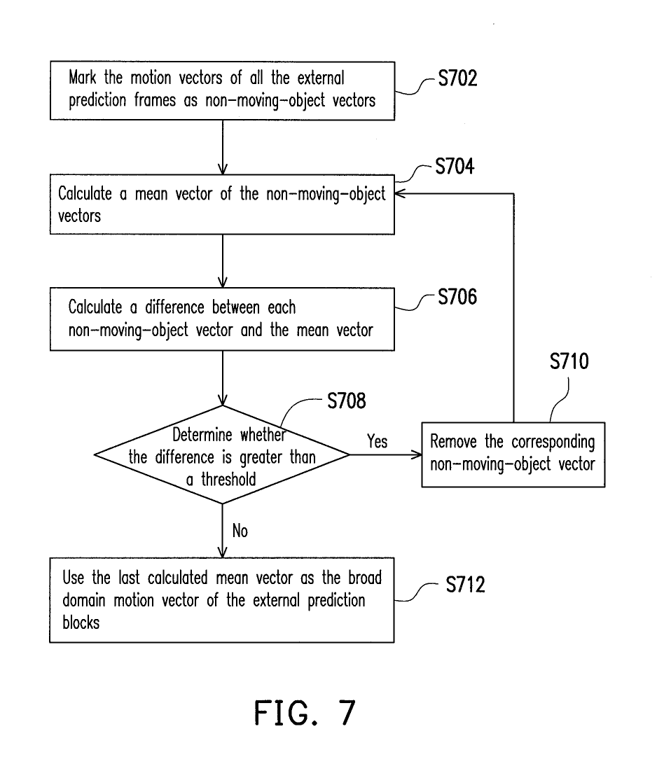

FIG. 7 is a flowchart illustrating a method for identifying moving object blocks by using a broad domain motion vector according to an embodiment of the disclosure. Referring to FIG. 7, the motion vector analysis unit 233 marks all the motion vectors in a same frame as non-moving-object vectors (step S702), calculates a mean vector of the non-moving-object vectors (step S704), calculates a difference (for example, a standard deviation of the Euclidian distance) between each non-moving-object vector and the mean vector (step S706), and compares the difference with a threshold (for example, two times of the standard deviation) to determine whether the difference is greater than the threshold (step S708). If the difference is greater than the threshold, the motion vector analysis unit 233 removes the corresponding non-moving-object vector (step S710) and then returns to step S704 to determine whether another non-moving-object vector needs to be removed. When there is no non-moving-object vector to be removed in step S706, the motion vector analysis unit 233 uses the last calculated mean vector as the broad domain motion vector of all the external prediction blocks (step S712).

After calculating the broad domain motion vector, the motion vector analysis unit 233 calculates a standard deviation of the Euclidian distance between each motion vector and the broad domain motion vector, serves the standard deviation as a boundary value, and marks blocks corresponding to the motion vectors which have the Euclidian distance to the broad domain motion vector greater than the standard deviation as blocks probably belonging to a moving object.

Referring to FIG. 5 again, next, the correlation analysis unit 234 calculates a correlation of each external prediction block by using a correlation analysis algorithm, so as to determine whether the external prediction block belongs to a moving object (step S508). Aforementioned correlation analysis algorithm includes temporal correlation analysis and spatial correlation analysis, which is respectively explained below.

Regarding the temporal correlation analysis of each external prediction block, the correlation analysis unit 234 determines whether two corresponding blocks at the same position in a previous frame and a next frame as the external prediction block belong to a moving object. If none of the two corresponding blocks belongs to the moving object, the correlation analysis unit 234 determines that the external prediction block does not belong to the moving object. Otherwise, the correlation analysis unit 234 determines that the external prediction block belongs to the moving object.

Regarding the spatial correlation analysis of external prediction blocks, the correlation analysis unit 234 respectively calculates the correlation (for example, a correlation of the Euclidian distance) between each external prediction block in a same frame and a plurality of adjoining blocks around the external prediction block. If the adjoining block having the largest correlation does not belong to a moving object, the correlation analysis unit 234 determines that the external prediction block does not belong to the moving object. Otherwise, the correlation analysis unit 234 determines that the external prediction block belongs to the moving object.

The object aggregating unit 235 aggregates those external prediction blocks that belong to the moving object and are connected with each other into moving object blocks and generates moving object information (step S510). To be specific, regarding each moving object block which belongs to no aggregation, the object aggregating unit 235 establishes a new aggregation and checks whether any adjoining block around each unprocessed block in the new aggregation belongs to the moving object. If there are such blocks, the blocks are placed into the aggregation. The object aggregating unit 235 repeats this operation until there is no unprocessed block in the aggregation.

It should be noted that aforementioned aggregation may contain more than one moving object. In order to separate the moving objects completely, the object aggregating unit 235 further performs a histogram analysis on the motion vectors of all blocks in the aggregation. In this histogram, each pick represents an object. The object aggregating unit 235 partitions the aggregation according to the result of the histogram analysis so as to allow the partitioned blocks to form complete moving objects.

Each aggregation represents an object. The object aggregating unit 235 calculates a mean value of motion vectors of blocks in each aggregation and serves the mean value as the moving direction of the object. Finally, the object aggregating unit 235 sends analysis data (i.e., the total number of objects, the position, size, and moving direction of each object, and blocks of each moving object) to the information integration module 24.

A moving object detection result is obtained through the process described above, and this result may be integrated by the information integration module 24 into the pixel video frame decompressed by the decompression module 22 through an information hiding technique or some other techniques so that the pixel video frame itself carries moving object information. Herein the information integration module 24 may sequentially replace last few bits in the pixel value of each pixel of the pixel video frame in the pixel video data with the moving object information by using a least significant bit replacement algorithm. Below, an embodiment is described in detail.

If the information integration module 24 uses the least significant bit replacement algorithm, it may replace the last three bits (each pixel can have 9 bits) of the RGB value of each pixel in a pixel video frame with a plurality of bits of the moving object information from left to right and from top to bottom. For example, the moving object information is (1,19,18,32,3,4,2,16,16,19,18,3,4,8,8,25,18,3,4), in which the first 1 indicates that there is totally one object, the following 19 and 18 indicate that the position of the object is (19,18), 32 indicates that the size of the object is 32 4×4 blocks, 3 and 4 indicates that the moving direction is (3,4), 2 indicates that the object contains two blocks, 16 and 16 indicate that the size of the first block is 16×16, 19 and 18 indicate that the position of the first block is (19,18), 3 and 4 indicate that the motion vector of the first block is (3,4), 8 and 8 indicate that the size of the second block is 8×8, and 18 indicate that the position of the second block is (25,18), and 3 and 4 indicate that the motion vector of the second block is (3,4).

First, the first digit 1 of the moving object information is converted into 9 bits: 1₁₀=000000001₂. Then, the last three bits of the RGB value (11111111, 11111111, 11111111) of the pixel at the top left corner are sequentially replaced with the 9 bits (grouped as (000, 000, 001)) starting from the highest bit (i.e., (11111000, 11111000, 11111001)). Next, the second digit of the moving object information is hidden into the RGB value of the pixel to the right of the top left pixel by using the same technique. Accordingly, the remaining digits of the moving object information are sequentially hidden into the RGB values of the pixels from left to right and from top to bottom. Finally, the pixel video frame containing the moving object information is output.

As described above, in a moving object detection method based on a compressed domain provided by an embodiment of the disclosure, temporal and spatial normalizations are performed on the motion vectors of blocks in each frame in a compressed video data, and a broad domain motion vector of the frame is calculated by using the normalized motion vectors, so as to identify those blocks belonging to a moving object. Then, temporal and spatial correlation analyses are performed on blocks around those blocks that may belong to a moving object, so as to remove those blocks that unreliably belong to a moving object. Next, all moving object blocks in the frame are grouped into a plurality of block aggregations by using a region growing technique. Finally, a histogram analysis is performed on each block aggregation to achieve complete moving objects, and analysis data containing the position, size, moving direction, and blocks of each moving object is recorded. Thereby, the application of the disclosure is not limited to stationary video camera, and video data in the compression format of H.264, MPEG-1, or MPEG-2 (which uses not only a baseline profile) can also be processed.

As described above, the disclosure provides a moving object detection method and a moving object detection apparatus based on a compressed domain, in which motion vectors of video frames in the compressed domain are captured to carry out moving object detection, and the result of the moving object detection is integrated into a pixel video frame. Thereby, when a user receives the pixel video frame containing the result of the moving object detection, the user can directly obtain moving object information and carry out subsequent analysis.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A moving object detection method based on a compressed domain, comprising:
receiving a first compressed video data and a pixel video data;
detecting a moving object information in the first compressed video data;
integrating the moving object information into the pixel video data; and
outputting the pixel video data containing the moving object information.

2. The moving object detection method according to claim 1, wherein the step of detecting the moving object information in the first compressed video data comprises:
capturing motion vectors of a plurality of external prediction blocks in a compressed domain of each of a plurality of external prediction frames of the first compressed video data;
performing a normalization process on the motion vectors of the external prediction blocks;
calculating a broad domain motion vector by using the normalized motion vectors of the external prediction blocks, and removing background blocks from the external prediction blocks by using the calculated broad domain motion vector;
calculating a correlation of each of the external prediction blocks by using a correlation analysis algorithm, and accordingly determining whether the external prediction block belongs to a moving object; and
aggregating the external prediction blocks which belong to the moving object and are connected with each other into moving object blocks, so as to generate the moving object information.

3. The moving object detection method according to claim 2, wherein the step of performing the normalization process on the motion vectors of the external prediction blocks comprises:
performing the normalization process on the motion vector of each of the external prediction blocks in a reference direction of a reference frame of the external prediction block.

4. The moving object detection method according to claim 2, wherein the step of performing the normalization process on the motion vectors of the external prediction blocks comprises:
performing the normalization process on the motion vector of each of the external prediction blocks for a reference distance between the external prediction frame where the external prediction block is located and the external prediction frame that the external prediction block refers to.

5. The moving object detection method according to claim 2, wherein the step of performing the normalization process on the motion vectors of the external prediction blocks comprises:
respectively multiplying two motion vectors of each of the external prediction blocks by corresponding weights, adding up the two weighted motion vectors to obtain a combined motion vector, and serving the combined motion vector as the motion vector of the external prediction block.

6. The moving object detection method according to claim 2, wherein the step of performing the normalization process on the motion vectors of the external prediction blocks comprises:
calculating a mean vector of the motion vectors of a plurality of adjoining blocks around each of the external prediction blocks in a same external prediction frame;
calculating a difference between the motion vector of the external prediction block and the mean vector, and comparing the difference with a threshold; and
if the difference is greater than the threshold, replacing the motion vector of the external prediction block with the mean vector.

7. The moving object detection method according to claim 2, wherein the step of calculating the broad domain motion vector by using the normalized motion vectors of the external prediction blocks, so as to remove the background blocks from the external prediction blocks by using the calculated broad domain motion vector comprises:
marking all the motion vectors of the external prediction blocks as non-moving-object vectors;
calculating a mean vector of the non-moving-object vectors;
calculating a difference between each of the non-moving-object vectors and the mean vector, and comparing the difference with a threshold;
removing the non-moving-object vectors having the difference greater than the threshold; and
repeating foregoing steps until no non-moving-object vector is removed, and serving the last calculated mean vector as the broad domain motion vector of the external prediction blocks.

8. The moving object detection method according to claim 2, wherein the step of calculating the correlation of each of the external prediction blocks by using the correlation analysis algorithm, and accordingly determining whether the external prediction block belongs to the moving object comprises:
determining whether two corresponding blocks in a previous frame and a next frame at a same position as each of the external prediction blocks belong to the moving object; and
determining that the external prediction block does not belong to the moving object if the two corresponding blocks do not belong to the moving object, and determining that the external prediction block belongs to the moving object if the two corresponding blocks belong to the moving object.

9. The moving object detection method according to claim 2, wherein the step of calculating the correlation of each of the external prediction blocks by using the correlation analysis algorithm, and accordingly determining whether the external prediction block belongs to the moving object comprises:
respectively calculating a correlation between each of the external prediction blocks in a same external prediction frame and a plurality of adjoining blocks; and
determining that the external prediction block does not belong to the moving object if the adjoining block having the greatest correlation does not belong to the moving object, and determining that the external prediction block belongs to the moving object if the adjoining block having the greatest correlation belongs to the moving object.

10. The moving object detection method according to claim 2, wherein the step of aggregating the external prediction blocks which belong to the moving object and are connected with each other into moving object blocks, so as to generate the moving object information comprises:
performing a histogram analysis on the motion vectors of all blocks in each of the moving object blocks; and
partitioning the moving object block into complete moving objects according to a result of the histogram analysis.

11. The moving object detection method according to claim 1, wherein the pixel video data is decompressed from a second compressed video data.

12. The moving object detection method according to claim 11, wherein the step of decompressing the second compressed video data into the pixel video data comprises:
decompressing a plurality of internal prediction frames and a plurality of external prediction frames of the second compressed video data into a plurality of pixel video frames according to a profile specification of the second compressed video data, so as to generate the pixel video data.

13. The moving object detection method according to claim 12, wherein the profile specification comprises a baseline profile, a main profile, or a high profile.

14. The moving object detection method according to claim 1, wherein the step of integrating the moving object information and the pixel video data comprises:
sequentially replacing last a plurality of bits in a pixel value of each pixel of one or more pixel video frames in the pixel video data with the moving object information by using a least significant bit replacement algorithm.

15. The moving object detection method according to claim 1, wherein the first compressed video data comprises prediction frames (P-frames) and bidirectional frames (B-frames).

16. The moving object detection method according to claim 11, wherein the second compressed video data comprises intra frames (I-frames), P-frames, B-frames, and profiles.

17. A moving object detection apparatus based on a compressed domain, comprising:
a moving object detection module, configured to receive a first compressed video data and detect a moving object information in the first compressed video data; and
an information integration module, configured to integrate the moving object information into a received pixel video data and outputting the pixel video data containing the moving object information.

18. The moving object detection apparatus according to claim 17, wherein the moving object detection module comprises:
a motion vector capturing unit, configured to capture motion vectors of a plurality of external prediction blocks in the compressed domain of each of a plurality of external prediction frames of the first compressed video data;
a normalization processing unit, configured to perform a normalization process on the motion vectors of the external prediction blocks;
a motion vector analysis unit, configured to calculate a broad domain motion vector by using the normalized motion vectors of the external prediction blocks, and remove background blocks from the external prediction blocks by using the calculated broad domain motion vector;
a correlation analysis unit, configured to calculate a correlation of each of the external prediction blocks by using a correlation analysis algorithm, and accordingly determine whether the external prediction block belongs to a moving object; and
an object aggregating unit, configured to aggregate the external prediction blocks which belong to the moving object and are connected with each other into moving object blocks, so as to generate the moving object information.

19. The moving object detection apparatus according to claim 18, wherein the normalization processing unit performs the normalization process on the motion vector of each of the external prediction blocks in a reference direction of a reference frame of the external prediction block.

20. The moving object detection apparatus according to claim 18, wherein the normalization processing unit performs the normalization process on the motion vector of each of the external prediction blocks for a reference distance between the external prediction frame where the external prediction block is located and the external prediction frame that the external prediction block refers to.

21. The moving object detection apparatus according to claim 18, wherein the normalization processing unit respectively multiplies two motion vectors of each of the external prediction blocks by corresponding weights, adds up the two weighted motion vectors to obtain a combined motion vector, and serves the combined motion vector as the motion vector of the external prediction block.

22. The moving object detection apparatus according to claim 18, wherein the normalization processing unit calculates a mean vector of the motion vectors of a plurality of adjoining blocks around each of the external prediction blocks in a same external prediction frame, calculates a difference between the motion vector of the external prediction block and the mean vector, compares the difference with a threshold, and if the difference is greater than the threshold, replaces the motion vector of the external prediction block with the mean vector.

23. The moving object detection apparatus according to claim 18, wherein the motion vector analysis unit marks all the motion vectors of the external prediction blocks as non-moving-object vectors, calculating a mean vector of the non-moving-object vectors, calculates a difference between each of the non-moving-object vectors and the mean vector, compares the difference with a threshold, removes the non-moving-object vectors having the difference greater than the threshold, repeats foregoing steps until no non-moving-object vector is removed, and serves the last calculated mean vector as the broad domain motion vector of the external prediction blocks.

24. The moving object detection apparatus according to claim 18, wherein the correlation analysis unit determines whether two corresponding blocks in a previous frame and a next frame at a same position as each of the external prediction blocks belong to the moving object, determines that the external prediction block does not belong to the moving object if the two corresponding blocks do not belong to the moving object, and determines that the external prediction block belongs to the moving object if the two corresponding blocks belong to the moving object.

25. The moving object detection apparatus according to claim 18, wherein the correlation analysis unit respectively calculates a correlation between each of the external prediction blocks in a same external prediction frame and a plurality of adjoining blocks, determines that the external prediction block does not belong to the moving object if the adjoining block having the greatest correlation does not belong to the moving object, and determines that the external prediction block belongs to the moving object if the adjoining block having the greatest correlation belongs to the moving object.

26. The moving object detection apparatus according to claim 18, wherein the object aggregating unit performs a histogram analysis on the motion vectors of all blocks in each of the moving object blocks and partitions the moving object block into complete moving objects according to a result of the histogram analysis.

27. The moving object detection apparatus according to claim 17, further comprising:
a decompression module, configured to decompress a second compressed video data into the pixel video data.

28. The moving object detection apparatus according to claim 27, wherein the decompression module decompresses a plurality of internal prediction frames and a plurality of external prediction frames of the second compressed video data into a plurality of pixel video frames according to a profile specification of the second compressed video data, so as to generate the pixel video data.

29. The moving object detection apparatus according to claim 28, wherein the profile specification comprises a baseline profile, a main profile, or a high profile.

30. The moving object detection apparatus according to claim 17, wherein the information integration module sequentially replaces last a plurality of bits in a pixel value of each pixel of one or more pixel video frames in the pixel video data with the moving object information by using a least significant bit replacement algorithm.

31. The moving object detection apparatus according to claim 17, wherein the first compressed video data comprises P-frames and B-frames.

32. The moving object detection apparatus according to claim 27, wherein the second compressed video data comprises I-frames, P-frames, B-frames, and profiles.
